(19) United States
(12) Patent Application Publication
(10) Pub. No.: US 2006/0058171 A1
(43) Pub. Date: Mar. 16, 2006

(54) Optical glass and optical device

(75) Inventor: Manabu Izuki, Kobe-shi (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/270,872

(22) Filed: Nov. 8, 2005

(30) Foreign Application Priority Data
Sep. 11, 2004 (JP) 2004-325235

(51) Int. Cl. C03C 3/19

(52) U.S. Cl. 501/47

(57) ABSTRACT

An optical glass contains glass constituents by wt % as follows; P₂O₅: 20 to 30%, B2O3: 0.1 to 10%, Nb2O5: 25 to 45%, WO3: 9 to 25%, Bi₂O₃; 0.1 to 10%, BaO: 3 to 15%, Li₂O: 4 to 5.5%, Na₂O: 0 to 2%, K₂O: 0 to 2%, Na₂O+K₂O: 0 to 2%, Li₂O+Na₂O+K₂O: 4 to 6%, Al₂O₃: 0 to 3%, CaO: 0 to 5%, SrO: 0 to 5%, ZnO: 0 to 5%, Ta₂O₅: 0 to 5%, TiO₂: 0 to 5%

The present application claims priority to Japanese Patent Application No. 2004-325235 filed on Nov. 9, 2004, the entire content of which is hereby incorporated by reference.

### BACKGROUND OF THE INVENTION

1. Field of the Invention

The present invention relates to optical glasses and optical devices made of the optical glasses. More specifically, the present invention relates to optical glasses having a high refractive index (nd: 1.78 to 1.86) and a high dispersion (νd: 20 to 30) as optical constants, having a relatively low glass transition temperature and a small linear thermal expansion coefficient and thus being suitable for mold press forming, and optical devices made of such optical glasses.

2. Description of the Related Art

There have been known so-called mold press forming methods in which a glass being heated at or above the yield temperature is pressed with a heated die constituted of a pair of upper and lower dies to directly form a lens. These mold press forming methods include less fabrication processes than conventional lens forming methods involving cutting and polishing of the glass, thus enabling fabrication of lenses with lower costs within shorter time periods. From these reasons, in recent years, the mold press forming methods have been widely utilized as fabricating methods of optical devices such as glass lenses.

The mold press forming methods are broadly divided into re-heating methods and direct pressing methods. The re-heating methods prepare a gob preform or a polished preform having a substantially-final article shape, then heat the preform to the softening point again and then apply press forming thereto into a final article shape, with a pair of upper and lower dies being heated. On the other hand, the direct pressing methods directly drop molten glass drops onto a heated die from a glass melting furnace and then apply press forming thereto into a final article shape.

Both the mold press forming methods involve heating the pressing dies to near or above the glass transition temperature during applying forming to glass. Therefore, with increasing glass transition temperature, the pressing die becomes more prone to surface oxidation and metal-composition change, thereby resulting in reduction of the lifetime of the die and an increase of the production cost. It is possible to suppress the degradation of the die by applying forming in an atmosphere of inert gas such as nitrogen. However, this increases the complexity of the forming apparatus for performing the control of the atmosphere and also requires the running cost for the inert gas, thereby increasing the production cost. Therefore, it is desirable to employ a glass having a possible lowest glass transition temperature for the mold press forming method. Furthermore, it is preferable that the yield temperature is lower, similarly to the glass transition temperature. In addition thereto, in order to prevent the occurrence of cracks of the article during forming with the die, it is desirable that the glass has a smaller linear thermal expansion coefficient.

In the past, lead compounds have been employed, in order to reduce the glass transition temperatures and the linear thermal expansion coefficients of glasses. Further, lead compounds offer the effect of decreasing the liquid-phase temperatures of glasses and increasing the viscosities thereof, thus enabling dropping of glasses at lower temperatures. From these reasons, lead compounds have been widely used in glasses to be subjected to press forming using the direct pressing method.

However, in recent years, there have been grown concerns about negative influence of such lead compounds on human bodies. Therefore, there have been market requirements for nonuse of such lead compounds. Thus, various studies have been conducted about techniques for decreasing the glass transition temperatures, the yield temperatures and the linear thermal expansion coefficients of glasses without using lead compounds. There have been suggested glass compositions which offer high refractive indexes and great dispersions, as described in the prior arts 1 to 3.

[Prior Art 1] JP-A No. 8-157231

[Prior Art 2] U.S. Pat. No. 6,333,282

[Prior Art 3] JP-A No. 2003-238197

However, the glasses suggested in the above prior arts all contain great amounts of alkali metal constituents and therefore exhibit great linear thermal expansion coefficients and low viscosities, thereby exhibiting poor formability. Further, the glass suggested in the prior art 2 has a great Bi₂O₃ content and thus exhibits a great linear thermal expansion coefficient.

### SUMMARY OF THE INVENTION

It is a principle object of the present invention to provide optical glasses having a high refractive index and a large dispersion and having a low glass transition temperature and a small linear thermal expansion coefficient, in spite of substantially not containing lead compounds.

It is another object of the present invention to provide optical glasses suitable for mold pressing forming.

It is further an object of the present invention to provide optical devices having a high refractive index and a large dispersion, having excellent weather resistance, a small linear thermal expansion coefficient and high productivity and containing substantially no lead compounds.

In order to attain the aforementioned objects, the present inventors have earnestly conducted studies. As a result, they have found that it is possible to reduce the linear thermal expansion coefficients of glasses while maintaining their glass transition temperature at low temperatures by using P₂O₅—Nb₂O₅—WO₃ as the glass basic skeleton and by restricting the respective contents of alkali metal constituents and the total content of them to certain values or less. Further, they have found that addition of small amounts of SrO, BaO, B₂O₃ and the like can improve the stability of glasses. Thus, they have reached the present invention.

Namely, according to an aspect of the present invention, an optical glass contains glass constituents, by wt. %, as follows: P₂O₅: 20 to 30%, B₂O₃: 0.1 to 10%, Nb₂O₅: 25 to 45%, WO₃: 9 to 25%, Bi₂O₃: 0.1 to 10%, BaO: 3 to 15%, Li₂O: 4 to 5.5%, Na₂O: 0 to 2% (including 0), K₂O: 0 to 2% (including 0), Na₂O+K₂O: 0 to 2% (including 0), Li₂O+Na₂O+K₂O: 4 to 6%, Al₂O₃: 0 to 3% (including 0), CaO: 0 to 5% (including 0), SrO: 0 to 5% (including 0), ZnO: 0 to 5% (including 0), Ta₂O₅: 0 to 5% (including 0), TiO₂: 0 to 5% (including 0) Hereinafter, unless particularly specified, “%” means “wt. %”.

The invention itself, together with further objects and attendant advantages, will best be understood by reference to the following detailed description.

### DETAILED DESCRIPTION OF PREFERRED EMBODIMENTS

There will be described the reason of the aforementioned restriction of respective constituents of an optical glass according to the present invention.

First, P₂O₅ is a constituent (glass former) forming the glass skeleton. If the P₂O₅ content is less than 20%, this will degrade the stability of the glass, thereby increasing the tendency of devitrification. On the other hand, if the P₂O₅ content exceeds 30%, this will decrease the refractive index, thereby preventing the provision of desired optical constants. From these reasons, the P₂O₅ content is determined within the range of 20 to 30%. More preferably, the P₂O₅ content is within the range of 22 to 28%.

B₂O₃ is a constituent (glass former) forming the glass skeleton, similarly to P₂O₅. Addition of a small amount of B₂O₃ can further improve the stability of glass. Further, B₂O₃ offers the effect of reducing the linear thermal expansion coefficient. If the B₂O₃ content is less than 0.1%, it is impossible to provide the aforementioned effects. On the other hand, if the B₂O₃ content exceeds 10%, this will increase the tendency of devitrification and degrade the chemical durability, thereby resulting in reduction of the refractive index. From these reasons, the B₂O₃content is determined within the range of 0.1 to 10%. More preferably, the B₂O₃ content is within the range of 0.5 to 8%.

Nb₂O₅ offers the effect of increasing the refractive index and the dispersion. Nb₂O₅ also offers the effect of reducing the linear thermal expansion coefficient and improving the chemical durability. If the Nb₂O₅ content is less than 25%, it is impossible to provide the aforementioned effects. On the other hand, if the Nb₂O₅ content exceeds 45%, this will raise the glass transition temperature and increase the tendency of devitrification, thereby preventing the provision of a stable glass. From these reasons, the Nb₂O₅ content is determined within the range of 25 to 45%. More preferably, the Nb₂O₅ content is within the range of 25 to 40%.

WO₃ offers the effect of increasing the refractive index and the dispersion without raising the glass transition temperature, similarly to Nb₂O₅. If the WO₃ content is less than 9%, it is impossible to provide desired optical constants without raising the glass transition temperature. On the other hand, if the WO₃ content exceeds 25%, this will result in degradation of the color degree and the chemical durability of glass and increase of the specific weight. From these reasons, the WO₃ content is determined within the range of 9 to 25%. More preferably, the WO₃ content is within the range of 12 to 22%.

Bi₂O₃ offers the effects of increasing the refractive index and the dispersion of glass and reducing the glass transition temperature. Addition of Bi₂O₃ together with Nb₂O₅ and WO₃ offers the effect of suppressing the tendency of devitrification. If the Bi₂O₃ content is less than 0.1%, it is impossible to provide the aforementioned effects. On the other hand, if the Bi₂O₃ content exceeds 10%, this will degrade the color degree of the glass and increase the linear thermal expansion coefficient and the specific weight. From these reasons, the Bi₂O₃ content is determined within the range of 0.1 to 10%. More preferably, the Bi₂O₃ content is within the range of 0.1 to 7%.

BaO offers the effect of suppressing the tendency of devitrification of the glass, namely improving the stability of the glass. If the BaO content is less than 3%, it is impossible to provide the aforementioned effects. On the other hand, if the BaO content exceeds 15%, this will reduce the dispersion thereby preventing the provision of desired optical constants, and this will further degrade the chemical durability. From these reasons, the BaO content is determined within the range of 3 to 15%. More preferably, the BaO content is within the range of 5 to 15%.

Alkali metal constituents R′₂O (R′=Li, Na, and K) offer the effect of reducing the glass transition temperature. Among them, Li₂O offers the effect of significant reduce of the glass transition temperature. If the Li₂O content is less than 4%, this will increase the tendency of devitrification of the glass and degrade the color degree, as well as raising the glass transition temperature. If the Li₂O content exceeds 5.5%, this will increase the linear thermal expansion coefficient thus resulting in cracks during press forming, and this will further degrade the chemical durability and reduce the glass viscosity. From these reasons, the Li₂O content is determined within the range of 4 to 5.5%. More preferably, the Li₂O content is within the range of 4.5 to 5.5%.

Further, it is possible to add other alkali metal constituents, namely Na₂O or K₂O. However, if the contents of respective alkali metal constituents and the total of them exceed 2%, this will increase the linear thermal expansion coefficient. From this reason, the Na₂O content and the K₂O content and the total of them are determined to 2% or less.

If the total content of R′₂O constituents is less than 4%, this will make impossible to provide the effect of reducing the glass transition temperature and also will increase the tendency of devitrification and will degrade the color degree. On the other hand, if the total content of R′₂O constituents exceeds 6%, this will increase the linear thermal expansion coefficient, thus resulting in cracks during press forming. From these reasons, the total content of R′₂O constituents is determined within the range of 4 to 6%.

Al₂O₃ offers the effect of improving the chemical durability. If the Al₂O₃ content exceeds 3%, this will degrade the meltability and will increase the tendency of devitrification. From this reason, the Al₂O₃ content is determined to 3% or less.

Addition of CaO and SrO together with BaO offers the effect of suppressing the tendency of devitrification of the glass. However, if the contents of CaO and SrO exceed 5%, this may reduce the dispersion. Therefore, the CaO content and the SrO content are each determined to 5% or less.

ZnO offers the effect of reducing the glass transition temperature. However, if the ZnO content exceeds 5%, this will increase the tendency of devitrification, thereby increasing the difficulty of providing a stable glass. Therefore, the ZnO content is determined to 5% or less.

Ta₂O₅ offers the effect of increasing the refractive index. However, if the Ta₂O₅ content exceeds 5%, this will increase the tendency of devitrification, thereby increasing the difficulty of providing a stable glass. Therefore, the Ta₂O₅ content is determined to 5% or less.

TiO₂ offers the effect of increasing the refractive index and the dispersion. Also, addition of TiO₂ together with Nb₂O₅, WO₃ and Bi₂O₃ offers the effect of suppressing the tendency of devitrification. However, if the TiO₂ content exceeds 5%, this will degrade the color degree and will raise the glass transition temperature. Therefore, the TiO₂ content is determined to 5% or less.

Addition of a small amount of Sb₂O₃ offers the effect of enhancing the refining effect and also offers the effect of suppressing the degradation of the color degree of glass. Therefore, it is preferable to add Sb₂O₃ by 0.5% or less as an external ratio.

As a matter of course, the optical glass according to the present invention may contain conventionally-known glass constituents and additives such as La₂O₃, ZrO₂, SiO₂, GeO₂, Gd₂O₃, as required, within the range which exerts no adverse influence upon the effects of the present invention.

An optical device according to the present invention is fabricated by applying mold press forming to the aforementioned optical glass. As the mold press forming method, there are a direct-press forming method which drops molten glass from a nozzle into a die being heated at a predetermined temperature and then applies press forming thereto and a reheating forming method which places a preform material onto a die, then heats it to a temperature equal to or higher than the glass softening point and then applies press forming thereto. These methods eliminate the necessity of polishing and cutting processes, which improves the productivity and enables provision of optical devices having a shape difficult to process such as sculptured surfaces or non-spherical surfaces.

Although the condition of forming is varied depending on the glass constituents and the shape of the to-be-formed article, in general, the die temperature is preferably within the range of 350 to 600° C. and is more preferably within a temperature range around the glass transition temperature. Further, the pressing time is preferably within the range of several seconds to several tens of seconds. The pressing pressure is varied depending on the shape and the size of the lens and is preferably within the range of 200 kgf/cm² to 600 kgf/cm². The greater the pressing pressure, the higher the accuracy of forming. The viscosity of glass during forming is preferably within the range of 10¹ to 10¹² poises.

Optical devices according to the present invention may be used as lenses in digital cameras or collimator lens, prisms, mirrors in laser beam printers.

### EXAMPLES

Hereinafter, the present invention will be described in more detail, with reference to examples. However, the present invention is not intended to be limited to these examples.

### Examples 1 to 10 and Comparison Examples 1 to 7

A metaphosphate or phosphate was employed as a P₂O₅ raw material. Further, other constituents such as carbonates, nitrates and oxides and so on were employed as raw materials. The glass raw materials were mixed such that target compositions illustrated in Table 1 and Table 2 were provided. Then, the powers of the raw materials were sufficiently mixed to form compound raw materials. The compound raw materials were introduced into a platinum crucible within an electric furnace being heated at a temperature within the range of 1000 to 1200° C. to melt and fine them. Thereafter, the materials were agitated to homogenize them. The materials were poured into a pre-heated metal die. Then, the materials were gradually cooled to a room temperature and, thus the fabrication of the respective samples was completed. For the respective samples, measurements of the refractive index nd for the D ray, the Abbe number νd, the glass transition temperature Tg, the yield temperature At and the linear thermal expansion coefficient α for the range of 100 to 300° C. were conducted. Table 1 and Table 2 illustrate the result of measurements.

The comparison examples 1 and 2 were additional tests of examples 10 and 11 of the prior art 1 (JP-A No. 8-157231). The comparison examples 3 to 5 were additional tests of examples 1, 5 and 14 of the prior art 2 (U.S. Pat. No. 6,333,282). The comparison examples 6 and 7 were additional tests of examples 1 and 3 of the prior art 3 (JP-A No. 2003-238197). The aforementioned measurements of glass characteristics were conducted in accordance with testing methods compliant with Japan Optical Glass Industrial Standards (JOGIS). The values of the refractive index nd and the Abbe number νd were obtained under a condition where the gradual cooling was performed at −30° C./hour. The measurements of the glass transition temperature Tg, the yield temperature At and the linear thermal expansion coefficient α for the range of 100 to 300° C. were conducted using a thermal mechanical analysis apparatus “TMA/SS6000” (manufactured by Seiko Instruments Inc.), under a condition where the temperature was raised at 10° C./second.

TABLE 1

| | | EXAMPLES | | | | | | | | | |
|---|---|---|---|---|---|---|---|---|---|---|---|
| | | 1 | 2 | 3 | 4 | 5 | 6 | 7 | 8 | 9 | 10 |
| wt % | P₂O₅ | 24.5 | 24.5 | 24.5 | 24.5 | 24.5 | 24.5 | 25.5 | 24.5 | 25 | 25 |
| | B₂O₃ | 6.0 | 6.0 | 4.0 | 4.0 | 6.0 | 7.5 | 2.0 | 7.0 | 5.0 | 6.0 |
| | Nb₂O₅ | 31.0 | 31.0 | 31.5 | 31.5 | 29.0 | 31.5 | 31.5 | 31.5 | 34.0 | 38.0 |
| | WO₃ | 16.0 | 16.0 | 16.0 | 16.0 | 16.0 | 16.0 | 16.0 | 9.0 | 20.3 | 10.5 |
| | Bi₂O₃ | 3.0 | 3.0 | 3.0 | 3.0 | 3.0 | 3.0 | 3.0 | 10.0 | 0.2 | 5.0 |
| | BaO | 10.0 | 10.0 | 10.0 | 10.0 | 14.5 | 10.0 | 10.0 | 10.0 | 10.0 | 8.0 |
| | Li₂O | 5.0 | 5.0 | 5.0 | 5.0 | 5.0 | 4.0 | 4.0 | 5.0 | 5.0 | 5.5 |
| | Na₂O | 0.5 | | 0.5 | 0.5 | | 1.0 | 2.0 | 0.5 | | |
| | K₂O | | 0.5 | | | | | | | 0.5 | |
| | Al₂O₃ | | | | 1.5 | | | | | | |
| | CaO | | | | | | | | | | |
| | SrO | 2.0 | 2.0 | | | | | | | | 2.0 |
| | ZnO | | | 3.5 | 2.0 | | 0.5 | 4.0 | 0.5 | | |
| | TiO₂ | 2.0 | 2.0 | 2.0 | 2.0 | 2.0 | 2.0 | 2.0 | 2.0 | | |
| | SiO₂ | | | | | | | | | | |
| | Sb₂O₃ | 0.03 | 0.03 | 0.03 | 0.03 | 0.03 | 0.03 | 0.03 | 0.03 | 0.03 | 0.03 |
| Nd | | 1.817 | 1.817 | 1.832 | 1.825 | 1.811 | 1.819 | 1.836 | 1.824 | 1.818 | 1.826 |
| νd | | 25.62 | 25.42 | 25.01 | 25.27 | 26.37 | 24.93 | 24.65 | 25.38 | 25.33 | 25.37 |
| Tg (° C.) | | 493 | 488 | 482 | 485 | 492 | 491 | 490 | 480 | 494 | 489 |
| At (° C.) | | 542 | 554 | 526 | 543 | 549 | 558 | 551 | 533 | 562 | 553 |

| | | | | | | | | | | |
|---|---|---|---|---|---|---|---|---|---|---|
| α (×10⁻⁷/K) | 96 | 93 | 95 | 95 | 97 | 87 | 99 | 98 | 90 | 93 |

TABLE 2

| | | COMPARISON EXAMPLES | | | | | | |
|---|---|---|---|---|---|---|---|---|
| | | 1 | 2 | 3 | 4 | 5 | 6 | 7 |
| wt % | P₂O₅ | 23.8 | 27.8 | 28.7 | 29.0 | 23.0 | 22.8 | 25.0 |
| | B₂O₃ | 2.6 | 2.6 | | | | 2.7 | 2.8 |
| | Nb₂O₅ | 38.3 | 39.8 | 27.7 | 34.4 | 38.0 | 38.0 | 28.7 |
| | WO₃ | 9.0 | 5.0 | | | 12.0 | 7.2 | 8.1 |
| | Bi₂O₃ | | | 34.8 | 26.6 | 10.0 | 11.8 | 6.0 |
| | BaO | 12.3 | 5.0 | | | 6.0 | 5.8 | 12.4 |
| | Li₂O | 3.0 | 2.0 | 3.8 | 3.6 | 3.0 | 2.5 | 3.0 |
| | Na₂O | 5.7 | 6.7 | 5.0 | 5.2 | 8.0 | 8.5 | 7.0 |
| | K₂O | 1.5 | 2.5 | | | | 0.7 | 1.5 |
| | Al₂O₃ | | | | | | | |
| | CaO | | | | | | | |
| | SrO | | | | | | | |
| | ZnO | | | | | | | |
| | TiO₂ | 3.6 | 8.6 | | | | | 5.5 |
| | GeO₂ | | | | 1.2 | | | |
| | SiO₂ | | | | | | | |
| | Sb₂O₃ | | | | | | 0.1 | 0.1 |

| | | | | | | | |
|---|---|---|---|---|---|---|---|
| nd | 1.8282 | 1.8442 | 1.8394 | 1.8380 | 1.8451 | 1.8263 | 1.8067 |
| νd | 24.30 | 21.44 | 24.71 | 24.37 | 23.97 | 24.55 | 25.23 |
| Tg (° C.) | 518 | 552 | 442 | 466 | 472 | 457 | 472 |
| At (° C.) | 562 | 602 | 486 | 511 | 529 | 517 | 531 |
| α (×10⁻⁷/K) | 108 | 95 | 126 | 113 | 126 | 123 | 126 |

As can be seen from Table. 1, the optical glasses of the examples 1 to 10 exhibited refractive indexes within the range of 1.811 to 1.836, Abbe numbers νd within the range of 24.7 to 26.4, which were desirable optical constants. Further, these optical glasses exhibited glass transition temperatures Tg of 494° C. or less, yield temperatures At of 562° C. or less and linear thermal temperature coefficients α of 99*10⁻⁷/K or less, which were suitable for mold press forming.

In view of meltability and productivity and formability, it is preferable that the refractive index nd is within the range of 1.78 to 1.86, the Abbe number νd is within the range of 20 to 30, the glass transition temperature Tg is equal to or less than 520° C. and the linear thermal expansion coefficient for the temperature range of 100 to 300° C. is equal to or less than 100*10-⁷/K.

On the contrary, the optical glasses of the comparison examples 1, 3 to 7 containing greater amounts of alkali metal constituents (Na₂O, in particular) all exhibited greater linear thermal expansion coefficients α, which were not suitable for mold press forming. The optical glass of the comparison example 2 exhibited a linear thermal expansion coefficient α falling within the desired range, but exhibited a glass transition temperature Tg of 552° C., which was not desirable in view of elongation of the life time of the die.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. An optical glass consisting essentially, expressed in term of weight percent, of:
P₂O₅: 20 to 30%,
B₂O₃: 0.1 to 10%,
Nb₂O₅: 25 to 45%,
WO₃: 9 to 25%,
Bi₂O₃: 0.1 to 10%,
BaO: 3 to 15%,
Li₂O: 4 to 5.5%,
Na₂O: 0 to 2% (including 0),
K₂O: 0 to 2% (including 0),
Na₂O+K₂O: 0 to 2% (including 0),
Li₂O+Na₂O+K₂O: 4 to 6%,
Al₂O₃: 0 to 3% (including 0),
CaO: 0 to 5% (including 0),
SrO: 0 to 5% (including 0),
ZnO: 0 to 5% (including 0),
Ta₂O₅: 0 to 5% (including 0),
TiO₂: 0 to 5% (including 0).

2. An optical glass according to claim 1, wherein the glass has a refractive index between 1.78 and 1.86.

3. An optical glass according to claim 1, wherein the glass has an Abbe number between 20 and 30.

4. An optical glass according to claim 1, wherein the glass has a glass transition temperature of not more than 520° C.

5. An optical glass according to claim 1, wherein a linear thermal expansion coefficient for the temperature range of 100 to 300° C. is equal to or less than 100*10-⁷/K.

6. An optical element made of an optical glass, the glass consisting essentially, expressed in term of weight percent, of:
P₂O₅: 20 to 30%,
B₂O₃: 0.1 to 10%,
Nb₂O₅: 25 to 45%,
WO₃: 9 to 25%,
Bi₂O₃: 0.1 to 10%,
BaO: 3 to 15%,
Li₂O: 4 to 5.5%,
Na₂O: 0 to 2% (including 0),
K₂O: 0 to 2% (including 0),
Na₂O+K₂O: 0 to 2% (including 0),
Li₂O+Na₂O+K₂O: 4 to 6%,
Al₂O₃: 0 to 3% (including 0),
CaO: 0 to 5% (including 0),
SrO: 0 to 5% (including 0),
ZnO: 0 to 5% (including 0),
Ta₂O₅: 0 to 5% (including 0),
TiO₂: 0 to 5% (including 0).

7. A method of manufacturing an optical element, comprising steps of:
providing an optical glass consisting essentially expressed in term of weight percent, of:
P₂O₅: 20 to 30%,
B₂O₃: 0.1 to 10%,
Nb₂O₅: 25 to 45%,
WO₃: 9 to 25%,
Bi₂O₃: 0.1 to 10%,
BaO: 3 to 15%,
Li₂O: 4 to 5.5%,
Na₂O: 0 to 2% (including 0),
K₂O: 0 to 2% (including 0),
Na₂O+K₂O: 0 to 2% (including 0),
Li₂O+Na₂O+K₂O: 4 to 6%,
Al₂O₃: 0 to 3% (including 0),
CaO: 0 to 5% (including 0),
SrO: 0 to 5% (including 0),
ZnO: 0 to 5% (including 0),
Ta₂O₅: 0 to 5% (including 0), and
TiO₂: 0 to 5% (including 0); and
molding the glass in a mold having a configuration corresponding to the optical element.
